(19) United States
(12) Patent Application Publication
(10) Pub. No.: US 2006/0286251 A1
(43) Pub. Date: Dec. 21, 2006

(54) Reversibly swellable granular starch-lipid composites and methods of making the same

(76) Inventors: Kyungsoo Woo, Shawnee, KS (US); Sukh D. Bassi, Atchison, KS (US); Clodualdo C. Maningat, Platte City, MO (US); Lianfu Zhao, Atchison, KS (US); Ramaswamy Mani, Platte City, MO (US)

Correspondence Address: LATHROP & GAGE LC, 4845 PEARL EAST CIRCLE, SUITE 300, BOULDER, CO, 80301, US

(21) Appl. No.: 11/146,671

(22) Filed: Jun. 7, 2005

(51) Int. Cl. A23L 1/05

(52) U.S. Cl. 426/578

(57) ABSTRACT

Starch-lipid composites are prepared by heat treatment of thermally stable granular starch with lipids under controlled conditions. The granular starch-lipid composites display unique properties including excellent cold and hot water swelling characteristics and the formation of stable emulsions. The products are useful as dispersing agents, thickening agents, fat substitutes and carriers for lipid-soluble active ingredients in foods, personal care and pharmaceutical applications.

### FIELD OF THE INVENTION

The present invention relates generally to reversibly swellable granular starch-lipid composites and methods of preparing those products. Individual, chemically cross-linked starch granules interact with lipids to form composites that have favorable characteristics. For example, the composites are capable of extremely rapid hydration in hot or cold water and they form exceptionally stable emulsions.

### BACKGROUND

Granular cold water swelling starches are well known. These starches can be prepared by suspending wet native starch granules in rapidly moving hot air and subsequently decreasing humidity (U.S. Pat. No. 4,280,851). Alternatively, they can be prepared by heating starch in an excess of water/alcohol with subsequent removal of liquid (U.S. Pat. No. 4,465,704).

When known granular cold water swelling starches are placed in hot or cold water, the granules swell excessively and release starch solubles into the aqueous phase. Upon drying, the individual swollen starch granules collapse and fuse together. Fused granules can be reground, but do not thereafter thicken efficiently and produce a dull taste in food products.

As a consequence of these properties, typical cold water swelling starches have only limited utility in food systems where gelling is to be avoided, e.g., in broths or other watery foods. In such watery systems, the conventional starches swell and gelatinize and release amylose, and upon storage give the food an unappealing texture. In addition, the fact that the known starches are not reversibly swellable (i.e., they are incapable of undergoing successive swelling/drying cycles) limits the utility of conventional starches.

Reversibly swellable starches can be produced by pre-swelling and cross-linking procedures such as those described in U.S. Pat. No. 6,299,907. This type of reversibly swellable starch is supplied by MGP Ingredients Inc. of Atchison, Kans. under the name SRS. The starches have a number of novel properties, including the ability to undergo multiple cycles of swelling and drying while substantially retaining the individuality of starch granules and leaching minimal amounts of starch solubles.

Starch can also be altered by chemical modification of the surface-bound proteins found on granule surfaces and in intergranular regions. For example, Seguchi et al. reported that starch hydrophobicity increased after heat treatment and chlorination. They reported a strong lipid binding ability after heat treatment at 120° C. for several hours. In support of this finding, Kato et al. reported that heat treatment of proteins such as ovalbumin and lysozyme resulted in an increase of surface hydrophobicity and decreased water solubility. It is speculated that heat treatment of surface-bound proteins may induce unfolding that leads to exposure of hydrophobic groups.

U.S. Pat. No. 3,091,567 discloses water repellent encapsulated starch products. A starch acid ester used for the formation of a water repellent dried film is disclosed. The starch ester is prepared by reacting an ungelatinized starch in an alkaline medium with a substituted cyclic carboxylic acid anhydride. The starch ester is reacted with polyvalent metal ions. Ingredients are trapped by suspending starch granules in water, heating with agitation to 180-200° F., mixing with active ingredients (oil, perfume, etc.) and drying. The dried particles slowly release oils or other entrapped materials over an extended period of time. Such disclosed starch products form a starch phase having oil droplets dispersed therein.

U.S. Pat. No. 5,882,713 discloses a method of making starch-lipid composites. The method includes jet cooking and cooling an aqueous mixture of starch and lipid. The high temperature and mechanical shear during the jet cooking dissolve granular starch, reduce its molecular weight and convert the lipid component into small droplets. Again, a solubilized starch paste, with a molecularly disrupted structure, contains lipid droplets dispersed and entrapped therein. Soft gels formed according to the methods disclosed in the 713 patent are incapable of surviving heat cycling without separating into two phases.

### SUMMARY

Starch-lipid composites have been prepared as new fat substitutes and active ingredient carriers. The composites are useful as dispersing agents, thickening agents, suspending agents, fat substitutes, waterproof coating materials, adhesives and carriers for lipid-soluble active ingredients in foods, personal care and pharmaceutical applications.

Starch granules used in the preparation of the starch-lipid composites described herein have been chemically modified by cross-linking. The cross-linking reduces or prevents rupture of the granules in solution, that would otherwise lead to paste formation. Starch granules may, but need not, be pre-swelled prior to cross-linking to form reversibly swellable starch. Surface-bound proteins on the intact granules are denatured, and the denatured proteins present hydrophobic moieties that form favorable electrostatic interactions with lipids. Therefore, intact granules are coated with and electrostatically bound to lipids according to the instrumentalities presented herein.

In one aspect, starch-lipid composites are prepared by heating thermally stable, cross-linked granular starch in the presence of lipids under continuous heating and mixing conditions. Stable composites are formed of individual starch granules coated with lipid. When reversibly swellable starch is used as the cross-linked starch, the composites are resilient to repeated washing with hot or cold water and display reversible swelling properties (i.e., the product can be dried and rehydrated). The composites also form stable emulsions with mixtures of oil and water without the use of emulsifying agents. Composites dispersed in aqueous and/or lipophilic media are very creamy in appearance with superior smoothness.

In another aspect, a starch-lipid composite includes a plurality of individual, cross-linked starch granules having denatured surface-proteins. The denatured surface-proteins interact with lipids.

In yet another aspect, a starch-lipid composite is produced by preparing an aqueous dispersion of a plurality of individual, cross-linked starch granules and a lipid, and heating the dispersion to denature surface-proteins of the starch granules. The denatured starch granules may be dried, and a second aqueous dispersion of the denatured starch granules and a lipid prepared.

### BRIEF DESCRIPTION OF THE DRAWINGS

FIG. 1 is a light micrograph (40×) of a SRS-lipid (10:2) composite formed of wheat starch and frying oil showing deposition of oil on the starch granule.

FIG. 2 is a scanning electron micrograph (2000×) of a SRS-lipid composite (10:2) formed by spray drying.

FIG. 3 shows scanning electron micrographs (4000×) of SRS-lipid composites.

FIG. 4 is a scanning electron micrograph (5000×) of a SRS-lipid composite.

FIG. 5 is a light micrograph (40×) of a SRS-lipid composite that was cut and stained with toluidine blue.

FIG. 6 is a transmission electron micrograph (10,000×) of a SRS-lipid composite sectioned by microtome.

### DETAILED DESCRIPTION

Cross-linked starch can be prepared using a wide variety of native starches, such as starches selected from the group consisting of cereal, root, tuber and legume. Further, cross-linked starches include those selected from wheat, corn, waxy corn, high amylose corn, oat, rice, tapioca, mung bean and potato. Substituted starches can also be used as starting materials, e.g., starches having hydroxypropyl or hydroxyethyl ethers as substituents. Starches may be cross-linked using cross-linking agents selected from, for example, phosphorylating agents, such as sodium trimetaphosphate and sodium tripolyphosphate, epichlorohydrin, and mixtures thereof.

The term “lipid” is used herein to refer to wholly or partially water-immiscible compounds. Lipids consist of a broad range of compounds that are soluble in organic solvents but less soluble in water. Lipids can be classified into three classes. Simple lipids subdivide into fats and waxes. Fats are composed of glycerol esters of fatty acids and waxes are composed of long chain fatty acids and long chain alcohols. A second class of lipids is compound lipids. In this class, specific compounds are conjugated to lipids, such as phosphate in phosphoglycerol; sphingomyosin, choline, and phosphate in sphingomyelins; sphingomylosine and simple sugars in cerebrocides. A third class of lipids includes those compounds not included in simple or compound lipids. Examples are carotenoid, steroids, fat soluble vitamins and the like.

Edible lipids suitable for food applications include but are not limited to soybean oil, flaxseed oil, canola oil, olive oil, peanut oil, hydrogenated oil, butter, lard, shortening, tallow, sesame oil, amaranth oil, omega-3 oil, margarine, paraffin oil and the like. For non-food applications, such as personal care applications, suitable lipids include but are not limited to, silicone oil, jojoba oil, wheat germ oil, rice bran oil, sphingolipids, phospholipids, glycosphingolipids, glycolipids, ceramide, waxes, rosin fatty acids, linseed oil, mineral oil, hydrocarbons, long chain ethers, amines, alcohols, carbonyl compounds and lipid soluble vitamins such as vitamin A, D, E and K.

Fragrances, emollients, coloring agents, octyl methoxy cinnamate, sunscreen actives, antiperspirant agents, insect repellent agents and the like may be used as additives.

In one embodiment, SRS is used as a thermally stable granular starch. SRS, lipids and water are placed in a homogenizing mixer. An emulsifying agent, maltodextrin, corn syrup solids, hydrocolloids, and/or proteins may be optionally added. The mixture is fed into a cooker with high speed mixing to prevent separation of the components. Mixing and heating may be accomplished by methods and devices known in the art, for example, temperature controlled reactors, steam jet cookers and/or extruders. Steam jet cooking of starch generally promotes mechanical shearing and rupture of polysaccharide molecules; however, the modified starch used herein appears to be resistant to such shearing and rupture under the conditions used.

In another embodiment, SRS is used as a thermally stable granular starch. SRS and water are placed in a homogenizing mixer, in the absence of lipids. Maltodextrin, corn syrup solids, hydrocolloids, and/or proteins may be optionally added. The mixture is fed into a cooker with high speed mixing. Mixing and heating may be accomplished by methods and devices known in the art, for example, temperature controlled reactors, steam jet cookers and/or extruders. The cooked starch mixture is then combined with a lipid, mixed at high speed and spray dried to create starch-lipid composites.

An additional process step of mixing the starch-lipid composites with lipid-soluble ingredients may be performed. Mixing may occur either in the solid state or in solution. In one embodiment, dried starch-lipid composite may be dispersed in an aqueous solution. The lipid-soluble ingredient may be added with mixing and the solution may be taken to dryness.

Composites produced according to the instrumentalities disclosed herein include lipids present in an amount equal to about 0.1-40 parts, preferably about 0.1-20 parts, and more preferably about 0.1-10 parts by dry weight of modified starch.

It will be understood that various procedures for denaturing proteins are known and that surface-proteins of starches may be denatured by variety of procedures, for example, by treatment with heat, acid, alkali, or ultraviolet radiation. “Surface-bound proteins” are found on granule surfaces and in intergranular regions.

The following examples set forth particular granular starch-lipid products in accordance with the instrumentalities reported herein, as well as methods of preparing such products. It is to be understood that these examples are provided by way of illustration only, and nothing therein should be taken as a limitation on the scope of what has been invented, which is defined by the claims that follow.

### EXAMPLES

In the following examples, ingredient proportions are expressed as weight relative to dry starch unless otherwise indicated. SRS-A and SRS-B were made by the following procedures:

SRS-A:

Wheat starch (100 parts, dry basis) was dispersed in 233 parts of water with 2 parts of sodium sulfate and mixed. After mixing for 30 minutes, sodium hydroxide (1.5 parts) was added. The reaction mixture was heated to 45° C. and continuously mixed at that temperature for 1 hour. For efficient cross-linking, 3.8 parts of sodium trimetaphosphate, 0.038 parts of sodium polyphosphate and 3 parts of sodium sulfate were added together. After further mixing for 20 hours at 45° C., the slurry was neutralized to pH 6.5 with dilute 1.0 N hydrochloric acid and cooled to 25° C. Starch was isolated by washing with water and spray drying.

SRS-B:

Wheat starch (100 parts, dry basis) was dispersed in 400 parts of water with 3 parts of sodium sulfate and mixed. After mixing for 30 minutes, sodium hydroxide (1.8 parts) was added. The reaction mixture was heated to 45° C. and continuously mixed at that temperature for 15 hours. The reaction mixture was cooled to 35° C. and additional sodium hydroxide (0.7 parts) was added. The reaction mixture was heated to 45° C. and continuously mixed at that temperature for 5 hour. For efficient cross-linking, 5.0 parts of sodium trimetaphosphate and 0.0004 parts of sodium polyphosphate were added together. After further mixing for 16 hours at 45° C., the slurry was neutralized to pH 6.5 with dilute 1.0 N hydrochloric acid and cooled to 25° C. Starch was isolated by washing with water and spray drying.

### Example 1

Ten parts granular reversibly swellable wheat starch (SRS-A), 1 part frying oil (Shortening, NIFDA, Atlanta, Ga.) and 10 parts water were placed in a stainless steel container and mixed at high speed to prevent phase separation of the mixture. The mixture was subjected to high pressure cooking by a steam jet cooker (Pick Steam Injection Sanitary Cooker, Pick Heaters, Inc, West Bend, Wis.). The back pressure of the steam jet cooker was 15 PSI and steam jet cooking was carried out at 212° F. with a flow rate of 5.1 L/min. The hot dispersion was collected and spray dried. The starch-lipid composite was characterized by cold water and hot water swelling tests as well as an emulsion stability test.

Testing

The composites were tested by cold water and hot water hydration tests. In the cold water hydration test, 5 g of starch-lipid composite was dispersed in 100 ml of distilled water at room temperature (approximately 25° C.) in a 250 ml beaker (e.g. Corning Pyrex beaker #1000-250) and then stirred continuously for 30 minutes. The composite/water mixture was then transferred to a 100 ml graduated cylinder (e.g. Corning Pyrex beaker #3062-100) and the swollen volume of the entire contents of the cylinder was measured after sitting for 24 hours at room temperature (approximately 25° C.). A swollen volume ratio for the cold water dispersion was determined by measuring the swollen volume (in milliliters) of the contents of the graduated cylinder and dividing this by the dry weight of the starch (in grams).

In the hot water hydration test, 5 g of starch-lipid composite was dispersed in 100 ml of distilled water at room temperature (approximately 25° C.) in a 250 ml beaker (e.g. Corning Pyrex beaker #1000-250) and then heated to 95° C. and stirred continuously for 30 minutes. The composite/water mixture was then transferred to a 100 ml graduated cylinder (e.g. Corning Pyrex beaker #3062-100) and the swollen volume of the entire contents of the cylinder was measured after sitting for 24 hours at room temperature (approximately 25° C.). A swollen volume ratio for the hot water dispersion was determined by measuring the swollen volume (in milliliters) of the contents of the graduated cylinder and dividing this by the dry weight of the starch (in grams).

An emulsion stability test also was performed. 5 g of starch-lipid composite was dispersed in 100 ml of a 1:1 mixture of distilled water and vegetable oil (e.g., soybean oil), at room temperature (approximately 25° C.) in a 250 ml beaker (e.g. Corning Pyrex beaker #1000-250) and then heated to 95° C. and stirred continuously for 30 minutes. The composite/oil/water mixture was then transferred to a 100 ml graduated cylinder (e.g. Corning Pyrex beaker #3062-100). The water/oil/composite dispersion was white in color and had a creamy appearance at 95° C. The dispersion was then allowed to sit for 24 hours at room temperature (approximately 25° C.). A water fraction formed on the bottom with a composite/oil fraction forming a stable emulsion on top of the water fraction. After 24 hours, the swollen volume of each of the fractions in the cylinder was measured. Swollen volume ratios for each of the fractions was determined by measuring the swollen volume (in milliliters) of a fraction and dividing this by the dry weight of the starch (in grams). Emulsion formation may be viewed as a decrease in the specific gravity of starch after composite formation.

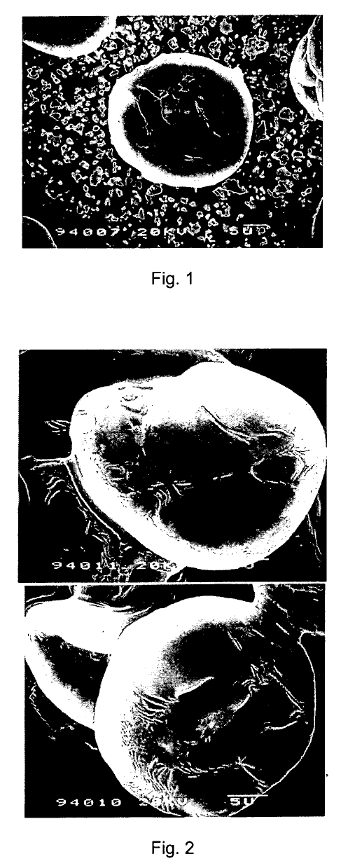

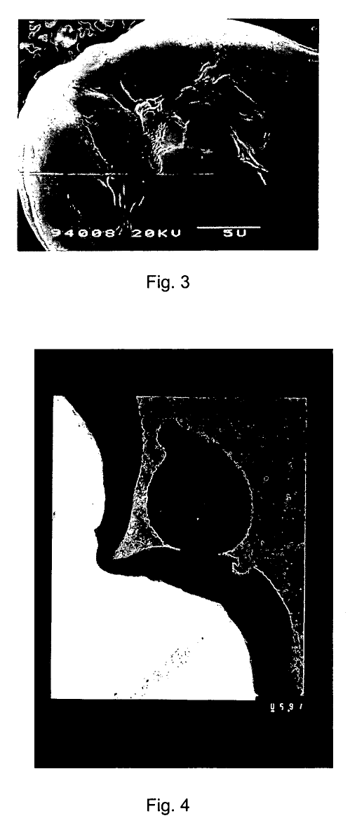

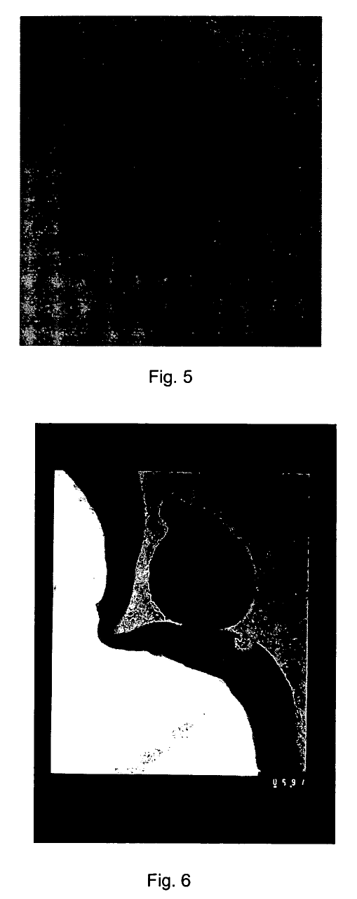

Following emulsion stability testing, the starch-lipid composite was stained with an iodine/potassium iodide solution and viewed through a light microscope (FIG. 1). Iodine binding was apparent within the granular structure of starch and less dense binding was observed on the surface of the granules. The lipophilic nature of the surface of the starch-lipid composite was shown by lipid droplets attracted to the surface of the composite (FIG. 1).

| | Swelling Volume | | Emulsion Stability at 95° C. (ml/g starch) | | |
|---|---|---|---|---|---|
| | (SV, ml/g starch) | | | Separated | Stable |
| | SV₂₅ | SV₉₅ | Precipitate | water | emulsion |
| Native | 2.4 | Gelled | Gelled | | |
| Wheat | | | | | |
| Starch | | | | | |
| SRS-A | 2.3 | 4.7 | 4.4 | 6.7 | 0 |
| SRS- | 5.1 | 5.3 | 0 | 4.6 | 16.4 |
| Lipid | | | | | |

### Example 2

Ten parts granular reversibly swellable wheat starch (SRS-A), one part silicone oil and 10 parts water were placed in a stainless steel container and mixed at high speed to prevent phase separation of the mixture. The mixture was subjected to high pressure cooking by a steam jet cooker (Pick Steam Injection Sanitary Cooker, Pick Heaters, Inc, West Bend, Wis.). The back pressure of the steam jet cooker was 22 PSI and the steam jet cooking was carried out at 250° F. with a flow rate of 5.1 L/min. The same procedure was followed for mixtures containing two and three parts, respectively, of silicone oil. When subjected to emulsion stability tests, these composites produced in accordance with Example 2 led to stable emulsion formation between the top of a water layer and the bottom of an oil layer.

| | | | Emulsion stability at | | |
|---|---|---|---|---|---|
| | Swelling Volume | | 95° C. (ml/g starch) | | |
| | (SV, ml/g starch) | | | Separated | Stable |
| Starch:Lipid | SV₂₅ | SV₉₅ | Precipitate | water | emulsion |
| 10:1 | 4.4 | 4.4 | 3.2 | 5.9 | 12.0 |
| 10:2 | 5.1 | 5.3 | 1.5 | 4.6 | 14.9 |
| 10:3 | 5.1 | 5.3 | 1.7 | 5.1 | 14.3 |

### Example 3

Ten parts granular reversibly swellable wheat starch (SRS-A) and 50 parts water were placed in a stainless steel container and mixed at high speed with a mixing paddle. Steam jet cooking was carried out at 121° F. The cooked starch was separated into 3 batches and cooled to 100° C., 60° C. and room temperature. Three parts silicone oil were added to each batch of starch. The starch, oil and water mixture was mixed at the selected temperature and subsequently dried.

| | | | | Emulsion stability at | | |
|---|---|---|---|---|---|---|
| | | Swelling Volume | | 95° C. (ml/g starch) | | |
| | | (SV, ml/g starch) | | | Separated | Stable |
| Starch:Lipid | | SV₂₅ | SV₉₅ | Precipitate | water | emulsion |
| 100° | C. | 3.7 | 4.4 | 1.8 | 5.8 | 12.5 |
| 60° | C. | 3.8 | 4.6 | 2.4 | 6.0 | 11.7 |
| 25° | C. | 4.2 | 3.8 | 2.6 | 6.7 | 10.9 |

### Example 4

Starch-lipid composites were prepared using a 10:1 mixture of starch and frying oil. The mixtures were subjected to temperatures of either 212° F. or 234° F. in the steam jet cooker using high pressure conditions at a flow rate of 5.1 L/min.

### Example 5

Ten parts granular reversibly swellable wheat starch (SRS-A), 1 part frying oil, xanthan gum as an emulsifying agent (1.5%, starch basis) and 100 parts water were combined in a stainless steel container and mixed at high speed with a mixing paddle. Steam jet cooking was carried out at 212° F. with a flow rate of 5.1 L/min.

| | | | Emulsion stability at | | |
|---|---|---|---|---|---|
| | Swelling Volume | | 95° C. (ml/g starch) | | |
| Xanthan | (SV, ml/g starch) | | | Separated | Stable |
| (starch basis) | SV₂₅ | SV₉₅ | Precipitate | water | emulsion |
| 1.5% | 5.1 | 5.3 | 1.2 | 4.0 | 15.9 |

### Example 6

Ten parts granular reversibly swellable wheat starch (SRS-B), 2 parts phytolipid, 2 parts glycerol monostearate and 100 parts water were placed in a glass beaker. The mixture was heated at 85° C. for 2 h and spray dried. The product was compared with a starch-lipid composite made from SRS-A using the same procedure (see table below).

| | | | Emulsion stability at | | |
|---|---|---|---|---|---|
| | Swelling Volume | | 95° C. (ml/g starch) | | |
| | (SV, ml/g starch) | | | Separated | Stable |
| | SV₂₅ | SV₉₅ | Precipitate | water | emulsion |
| SRS-A | 2.3 | 4.7 | 4.4 | 6.7 | — |
| SRS-A-Lipid | 8.1 | 7.1 | 8.5 | 2.9 | 9.3 |
| SRS-B | 2.5 | 5.1 | 5.5 | 4.3 | — |
| SRS-B-Lipid | 6.9 | 4.7 | 4.1 | 4.6 | 11.8 |

Phytolipids containing glycolipids, sphingolipids, glycosphingolipids, phospholipids and ceramides from biofermented grains were used in the present Example. The phytolipids were obtained by solvent extraction and supercritical fluid extraction. Solvent extraction may be accomplished using batch or continuous counter-current extractors of percolation or immersion design. After solvent extraction, the mixture is filtered and concentrated by distillation.

Phytolipids may be either a combination of polar and neutral lipids, or separated and extracted phytolipids from biofermented grains such as corn, milo, wheat, barley, rye, oats and rice. Lipids recovered from biofermented grains have compositions which are unique and unobtainable from pure grain. Phytolipids include triglycerides, free fatty acids, phytosterols, ceramides, phospholipids, ferrulic acid and vitamin E.

Changes may be made in the above methods and systems without departing from the invention described in the Summary and defined by the following claims. It should thus be noted that the matter contained in the above description or shown in the accompanying drawings should be interpreted as illustrative and not limiting.

All references cited are incorporated by reference herein.

We claim:

1. A starch-lipid composite comprising a plurality of individual, cross-linked starch granules having denatured surface-proteins, wherein said denatured surface-proteins interact with lipids.

2. The starch-lipid composite of claim 1, wherein said starch granules are cross-linked by a crosslinker selected from the group consisting of phosphorylating agents and epichlorohydrin.

3. The starch-lipid composite of claim 2, wherein said crosslinker is selected from the group consisting of sodium trimetaphosphate, sodium tripolyphosphate and mixtures thereof.

4. The starch-lipid composite of claim 1, wherein said starch granules are oxidized.

5. The starch-lipid composite of claim 1, wherein the cross-linked starch comprises reversibly swellable starch (SRS).

6. The starch-lipid composite of claim 1, wherein the lipid is present in an amount equal to about 0.1-40 parts by dry weight of modified starch.

7. The starch-lipid composite of claim 1, wherein a stable emulsion of at least about 0.5 ml/g starch is formed when the starch-lipid composite is dispersed in 100 ml of a 1:1 oil:water mixture and heated at 95° C. for 30 minutes.

8. The starch-lipid composite of claim 1, wherein the lipid is a selected from the group consisting of soybean oil, flaxseed oil, canola oil, olive oil, peanut oil, hydrogenated oil, butter, lard, shortening, tallow, sesame oil, amaranth oil, omega-3 oil, margarine, paraffin oil, silicone oil, jojoba oil, wheat germ oil, rice bran oil, sphingolipids, phospholipids, glycosphingolipids, glycolipids, ceramide, waxes, rosin fatty acids, linseed oil, mineral oil, hydrocarbons, long chain ethers, amines, alcohols, carbonyl compounds and lipid soluble vitamins such as vitamin A, D, E and K.

9. The starch-lipid composite of claim 1, wherein the lipid is a phytolipid.

10. The starch-lipid composite of claim 9, wherein the phytolipid is derived at least in part from biofermented grains.

11. The starch-lipid composite of claim 10, wherein the phytolipid comprises glycolipids, sphingolipids, glycosphingolipids, phospholipids, ceramides from biofermented grains and mixtures thereof.

12. The starch-lipid composite of claim 1, wherein said starch granules are derived from the group of starch sources consisting of cereal, root, tuber and legume.

13. The starch-lipid composite of claim 1, wherein said starch granules are derived from the group of starch sources consisting of wheat, corn, waxy corn, high amylose corn, oat, rice, tapioca, mung bean, potato and substituted starches thereof.

14. A formulation comprising the composition of claim 1, wherein the formulation is a food product.

15. A formulation comprising the composition of claim 1, wherein the formulation is a pharmaceutical product.

16. A formulation comprising the composition of claim 1, wherein the formulation is a personal care product.

17. A method for preparing a starch-lipid composite, said method comprising the following steps:
preparing an aqueous dispersion comprising a plurality of individual, cross-linked starch granules and a lipid; and
heating said dispersion to denature surface-proteins of said starch granules.

18. The method of claim 17, further comprising the steps of:
isolating the starch-lipid composite from said aqueous dispersion; and
preparing a second aqueous dispersion comprising the starch-lipid composite and a lipid-soluble ingredient.

19. A method for preparing a starch-lipid composite, said method comprising the following steps:
preparing an aqueous dispersion comprising a plurality of individual, cross-linked starch granules;
heating said dispersion to denature surface-proteins of said starch granules;
drying the denatured starch granules; and
preparing a second aqueous dispersion at room temperature comprising the denatured starch granules and a lipid.

20. The method of claim 19, further comprising the steps of:
isolating the starch-lipid composite from said second aqueous dispersion; and
preparing a third aqueous dispersion comprising the starch-lipid composite and a lipid-soluble ingredient.
